(19) United States
(12) Patent Application Publication
(10) Pub. No.: US 2011/0090313 A1
(43) Pub. Date: Apr. 21, 2011

(54) MULTI-EYE CAMERA AND METHOD FOR DISTINGUISHING THREE-DIMENSIONAL OBJECT

(76) Inventor: Akiyoshi TSUCHITA, Saitama (JP)

(21) Appl. No.: 12/904,182

(22) Filed: Oct. 14, 2010

(30) Foreign Application Priority Data
Oct. 15, 2009 (JP) 2009-238455

(51) Int. Cl. H04N 13/02; G06K 9/00

(52) U.S. Cl. 348/46; 382/154; 348/E13.074

(57) ABSTRACT

A stereo camera captures a pair of R and L viewpoint images. Upon a half press of a shutter release button, a preliminary photographing procedure is carried out. A binary image generator applies binary processing to each image, and a shadow extracting section extracts a shadow of a main subject from each binary image. A size calculating section calculates a size of each shadow, and a difference calculating section calculates a difference in size of the shadow between the images. If an absolute value of the difference is a size difference threshold value or more, the main subject is distinguished as a three-dimensional object suited to a 3D picture mode. Otherwise, the main subject is distinguished as a printed sheet suited to a 2D picture mode. Upon a full press of the shutter release button, an actual photographing procedure is carried out in the established 3D or 2D picture mode.

### BACKGROUND OF THE INVENTION

1. Field of the Invention

The present invention relates to a multi-eye camera that takes a plurality of viewpoint images with use of a plurality of imaging optical systems, and a method for distinguishing based on the viewpoint images whether or not a subject is a three-dimensional object.

2. Description Related to the Prior Art

A multi-eye camera that obtains a parallax image to get a three-dimensional view is widely known. The parallax image is a collection of two-dimensional viewpoint images. The conventional multi-eye camera is provided with a plurality of imaging optical systems to obtain the plural viewpoint images. In reproduction, these viewpoint images are merged to generate the parallax image.

Most of the multi-eye cameras are switchable between a 2D picture mode for obtainment of a single 2D image and a 3D picture mode for obtainment of the parallax image. This is because if a subject is a planar printed sheet such as a photograph, the parallax image of the subject cannot have depth. If anything, binocular disparity causes the subject hard to see. Thus, a user switches a photographing mode of the multi-eye camera depending on the subject, so as to choose the 3D picture mode if the subject is a three-dimensional object and choose the 2D picture mode if the subject is the printed sheet.

In recent years, some of the multi-eye cameras automatically distinguish whether the subject is the three-dimensional object or the printed sheet, and switch the photographing mode in accordance with a distinction result. This prevents forgetting about switching the photographing mode, and allows obtainment of the image suited to the subject.

As a method for distinguishing whether the subject is the three-dimensional object or the printed sheet, for example, Japanese Patent Laid-Open Publication No. 2002-245439 discloses a method for determining the shape of the subject from a shadow of a gray image taken by a camera. Also, in United States Patent Application Publication No. 2007/0195089, a shadow of a building taken in an aerial photograph and dimensions of the building are analyzed based on photographing information including a photographing date and time, a latitude and longitude of a photographed location, a photographed area, a photographing direction, an altitude of the camera above sea level, a camera angle, an angle of view, and the like.

In the method of the Japanese Patent Laid-Open Publication No. 2002-245439, however, the subject of the printed sheet is mistakenly distinguished as the three-dimensional object, when the printed sheet contains the shadow. Analyzing the shadow of the subject based on the photographing information, as described in the United States Patent Application Publication No. 2007/0195089, allows correct distinction of the subject, even if the printed sheet contains the shadow. This method, however, needs various sensors to obtain the photographing information, a shadow analyzing device, and the like, and results in upsizing and cost increase of the multi-eye camera.

As another method for distinguishing whether the subject is the three-dimensional object or the printed sheet, it is conceivable to use a well-known stereo matching technique. In the stereo matching technique, however, the main subject of the printed sheet is mistakenly distinguished as the three-dimensional object.

### SUMMARY OF THE INVENTION

A main object of the present invention is to provide a multi-eye camera that can appropriately distinguish whether a subject is a three-dimensional object or a printed sheet even if the printed sheet contains a shadow, and a method for appropriately distinguishing the subject.

Another object of the present invention is to provide the multi-eye camera that is small in size and inexpensive, and the distinction method that does not require upsizing and cost increase of the camera.

To achieve the above and other objects, a multi-eye camera according to the present invention includes a shadow extracting section, a size calculating section, a difference calculating section, and a distinguishing section. The shadow extracting section extracts a shadow of the same subject from each viewpoint image captured in a preliminary photographing procedure. The size calculating section calculates a size of the shadow extracted from each viewpoint image by the shadow extracting section. The difference calculating section calculates a difference in size of the shadow between the viewpoint images. The distinguishing section distinguishes the subject as a three-dimensional object suited to a 3D picture mode, if the difference is a size difference threshold value or more. The distinguishing section distinguishes the subject as a printed sheet suited to a 2D picture mode, if the difference is less than the size difference threshold value.

It is preferable that the multi-eye camera further include a mode switching section that automatically switches a photographing mode between the 2D picture mode and the 3D picture mode in accordance with a distinction result by the distinguishing section.

It is preferable that the preliminary photographing procedure be carried out upon a half press of a shutter release button, and an actual photographing procedure be carried out in the established photographing mode upon a full press of the shutter release button.

The multi-eye camera may further include an angle calculating section and a horizontal scaling section. The angle calculating section calculates a photographing angle of each imaging unit relative to the subject. The horizontal scaling section calculates a scaling rate based on the photographing angles of the imaging units calculated by the angle calculating section, and horizontally stretches or shrinks at the scaling rate the shadow extracted from at least one of the viewpoint images. The size calculating section calculates the size of the shadow after being processed by the horizontal scaling section.

The multi-eye camera may further include an image capture controller that obtains both of the parallax image and the viewpoint image in the actual photographing procedure, if the shadow is not extracted from any of the viewpoint images.

The multi-eye camera may further include a white defect extracting section that extracts a white defect of the same subject from each viewpoint image, in a case where the shadow is not extracted from any of the viewpoint images. The size calculating section calculates the size of the white defect extracted from each viewpoint image by the white defect extracting section. The difference calculating section calculates a difference in size of the white defect between the viewpoint images. The distinguishing section distinguishes the subject as the three-dimensional object, if the difference is the size difference threshold value or more. The distinguishing section distinguishes the subject as the printed sheet, if the difference is less than the size difference threshold value.

The horizontal scaling section may horizontally stretch or shrink at the scaling rate the white defect extracted from at least one of the viewpoint images. The size calculating section may calculate the size of the white defect after being processed by the horizontal scaling section.

A method for distinguishing whether a subject is a three-dimensional object or a printed sheet based on a plurality of viewpoint images includes the steps of extracting a shadow of a subject from each viewpoint image in a preliminary photographing procedure; calculating a size of the extracted shadow; calculating a difference in size of the shadow between the viewpoint images; and distinguishing the subject as the three-dimensional object if the difference is a size difference threshold value or more, and distinguishing the subject as the printed sheet if the difference is less than the size difference threshold value.

The method may further include the step of switching a photographing mode to a 3D picture mode for obtaining a parallax image if the subject is distinguished as the three-dimensional object, and switching the photographing mode to a 2D picture mode for obtaining the single viewpoint image if the subject is distinguished as the printed sheet.

According to the present invention, the shadow of the same subject is extracted from each of the plural viewpoint images captured in the preliminary photographing procedure. If the difference in size of the shadow between the viewpoint images is the predetermined size difference threshold value or more, the subject is distinguished as the three-dimensional object suited to the 3D picture mode. If the difference in size of the shadow between the viewpoint images is less than the size difference threshold value, the subject is distinguished as the printed sheet suited to the 2D picture mode. Thus, eve if the printed sheet contains the shadow, it is possible to precisely distinguish the subject between the three-dimensional object and the printed sheet, and choose the appropriate photographing mode. Since the multi-eye camera does not require various sensors and an analyzing device to conduct complex analysis, the multi-eye camera is realized without upsizing and cost increase.

### BRIEF DESCRIPTION OF THE DRAWINGS

For more complete understanding of the present invention, and the advantage thereof, reference is now made to the following descriptions taken in conjunction with the accompanying drawings, in which:

FIG. 1 is a front perspective view of a stereo camera;

FIG. 2 is a rear plan view of the stereo camera;

FIG. 3 is a block diagram of the stereo camera according to a first embodiment;

FIGS. 4A to 4H are explanatory views showing examples of a main subject before and after binary processing;

FIG. 5 is a flowchart of the stereo camera according to the first embodiment in an automatic switching mode;

FIG. 6 is a block diagram of a stereo camera according to a second embodiment;

FIG. 7 is an explanatory view of photographing angles of first and second imaging units relative to the main subject;

FIG. 8 is an explanatory view explaining a method for calculating the photographing angle;

FIG. 9 is a flowchart of a stereo camera according to the second embodiment;

FIGS. 10A to 10D are explanatory views showing examples of images of the main subject taken with the different photographing angles;

FIG. 11 is a block diagram of a stereo camera according to a third embodiment;

FIG. 12 is a flowchart of the stereo camera according to the third embodiment;

FIG. 13 is a block diagram of a stereo camera according to a fourth embodiment; and

FIG. 14 is a flowchart of the stereo camera according to the fourth embodiment.

### DESCRIPTION OF THE PREFERRED EMBODIMENTS

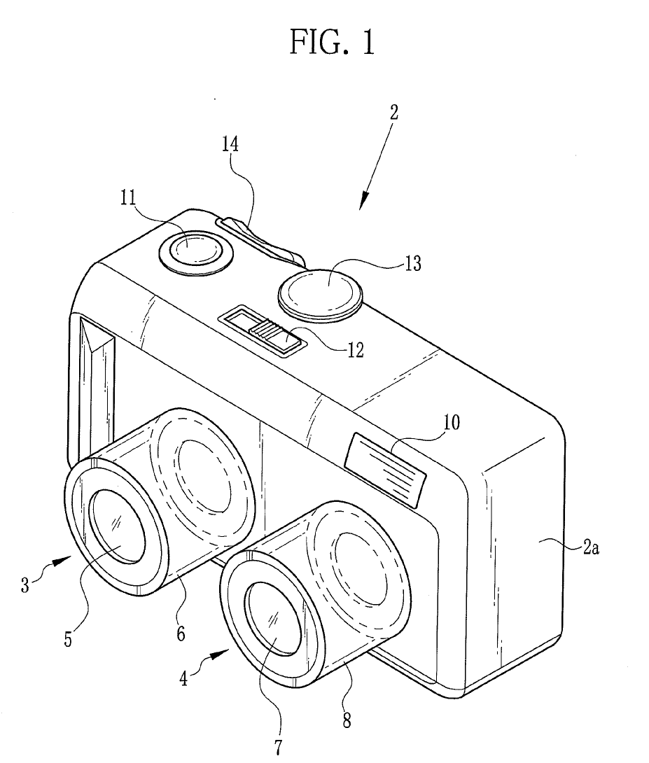

FIG. 1 shows a stereo camera 2, as an example of a multi-eye camera. The stereo camera 2 has a first imaging unit 3 and a second imaging unit 4, which are provided in a camera body 2a. The first and second imaging units 3 and 4 simultaneously take images, and obtain two viewpoint images having binocular disparity. Each viewpoint image is a planar 2D image. The viewpoint image taken by the first imaging unit 3 is called R viewpoint image, and the viewpoint image taken by the second imaging unit 4 is called L viewpoint image. The two viewpoint images are merged into a parallax image. The parallax image, being a collection of the two viewpoint images, is stored as a single multi-picture format image file.

The first imaging unit 3 has a first lens barrel 6 that contains a first imaging optical system 5. Likewise, the second imaging unit 4 has a second lens barrel 8 that contains a second imaging optical system 7. The first and second lens barrels 6 and 8 are attached to the camera body 2a so that optical axes of the lens barrels 6 and 8 are approximately in parallel with each other. Upon turning the stereo camera 2 off or during reproduction of the obtained image, each lens barrel 6, 8 retracts into the camera body 2a and is put in a retraction position, as illustrated by chain double-dashed lines of FIG. 1. During taking the image, on the other hand, each lens barrel 6, 8 protrudes from the front face of the camera body 2a and is set in a photographing position, as illustrated by solid lines of FIG. 1. In the front face of the camera body 2a, a flash light emitting unit 10 is provided to illuminate a subject with flash light.

On a top face of the camera body 2a, there is provided a shutter release button 11 for issuing a photographing command, a power switch 12 for turning the stereo camera 2 on or off, and a mode switching dial 13 for switching a mode of the stereo camera 2.

The stereo camera 2 is switchable among a 3D picture mode for obtaining the parallax image, a 2D picture mode for obtaining the 2D image taken by the first imaging unit 3, an automatic switching mode in which the photographing mode is automatically switched between the 3D picture mode and the 2D picture mode in accordance with the subject, and a reproduction mode for reproducing the obtained parallax or 2D image. By turning the mode switching dial 13, the stereo camera 2 is switched among the above modes.

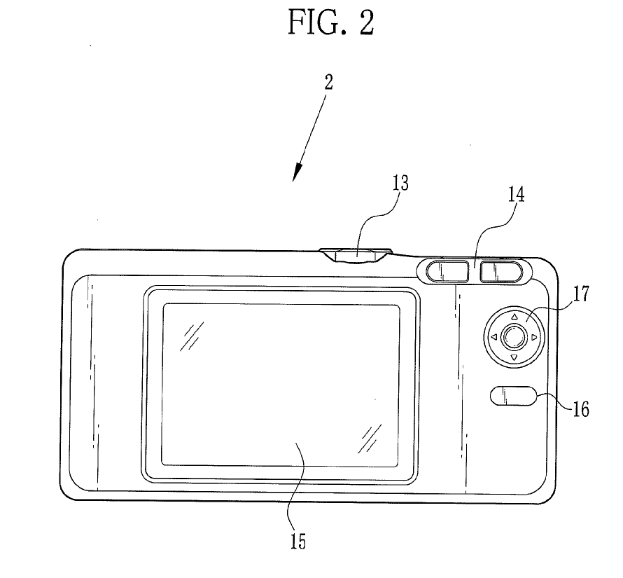

On a rear face of the camera body 2a, as shown in FIG. 2, there are provided a zoom button 14 for zooming the first and second imaging optical systems 5 and 7 in or out between a telephoto side and a wide-angle side, a liquid crystal display (LCD) 15 for displaying the obtained image, a live image, various menu screens, and the like, a menu button 16 for commanding display of the menu screen, and a cross key 17 used for choosing and entering items on the menu screen.

The LCD 15 is a so-called 3D display having a lenticular lens on a surface. Thus, in the stereo camera 2, a user can see a 3D view of a stereoscopic image displayed on the LCD 15 by naked eyes. Also, the user can see the 2D image on the LCD 15.

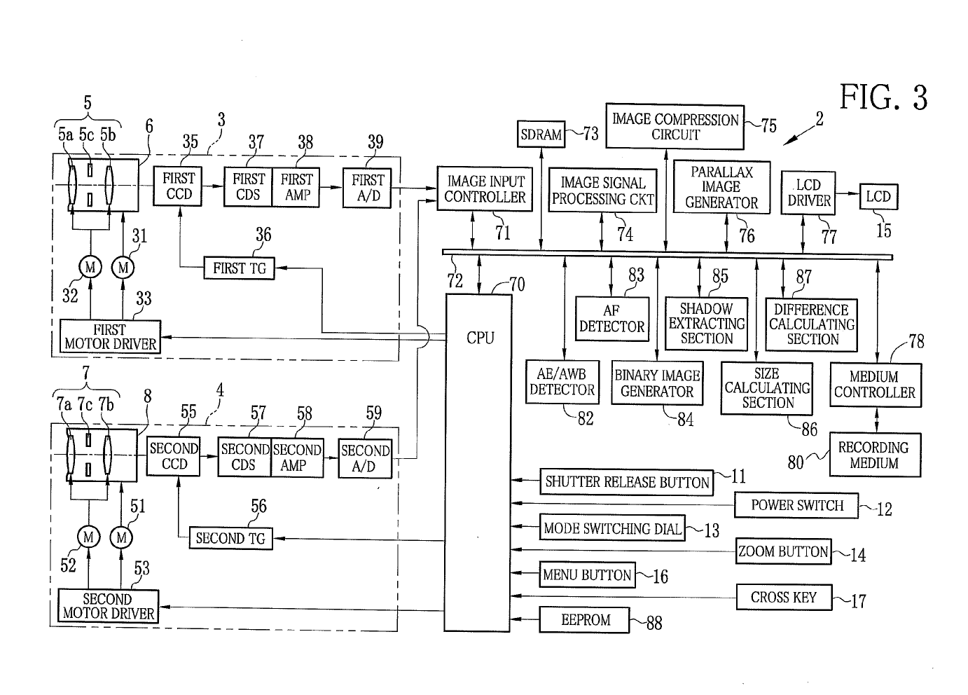

As shown in FIG. 3, the first imaging unit 3 is constituted of the first lens barrel 6, a first drive motor 31, a first focus motor 32, a first motor driver 33, a first CCD 35, a first timing generator (first TG) 36, a first correlated double sampling circuit (first CDS) 37, a first amplifier (first AMP) 38, and a first analog-to-digital converter (first A/D) 39.

The first lens barrel 6 contains a zooming lens 5a, a focusing lens 5b, and an aperture stop 5c, which compose the first imaging optical system 5. The first drive motor 31 moves the first lens barrel 6 between the photographing position and the retraction position. The first focus motor 32 shifts the zooming lens 5a and the focusing lens 5b in an optical axis direction. The motors 31 and 32 are connected to the first motor driver 33. The first motor driver 33 is connected to a CPU (functioning as a distinguishing section, a mode switch section, and an image capture controller) 70 for controlling the whole of the stereo camera 2, and drives each of the motors 31 and 32 in response to a control signal from the CPU 70.

The first CCD 35 is disposed behind the first imaging optical system 5. The first imaging optical system 5 forms a subject image on a light receiving surface of the first CCD 35. The first CCD 35 is connected to the first TG 36. The first TG 36 is connected to the CPU 70, and inputs a timing signal (clock pulses) to the first CCD 35 under control of the CPU 70. The first CCD 35 captures the subject image formed on the light receiving surface in response to the timing signal, and outputs an image signal corresponding to the subject image.

The image signal outputted from the first CCD 35 is inputted to the first CDS 37. The first CDS 37 converts the inputted image signal into image data of R, G, and B that precisely corresponds to the amounts of electric charges accumulated in individual cells of the first CCD 35. The image data outputted from the first CDS 37 is amplified by the first AMP 38, and is converted into digital image data by the first A/D 39. The digital image data is inputted from the first A/D 39 to an image input controller 71 as an R viewpoint image.

As in the case of the first imaging unit 3, the second imaging unit 4 is constituted of the second lens barrel 8, a second drive motor 51, a second focus motor 52, a second motor driver 53, a second CCD 55, a second timing generator (second TG) 56, a second correlated double sampling circuit (second CDS) 57, a second amplifier (second AMP) 58, and a second analog-to-digital converter (second A/D) 59. These components of the second imaging unit 4 are identical to those of the first imaging unit 3, and detailed description thereof will be omitted. An image signal captured by the second CCD 55 is converted into image data by the second CDS 57. The image data is amplified by the second AMP 58, and is digitized by the second A/D 59. Then, the digital image data is inputted from the second A/D 59 to the image input controller 71 as an L viewpoint image.

The image input controller 71 is connected to the CPU 70 through a data bus 72. The image input controller 71 writes the R viewpoint image inputted from the first imaging unit 3 and the L viewpoint image inputted from the second imaging unit 4 to an SDRAM 73 under control of the CPU 70.

An image signal processing circuit 74 reads each of the R and L viewpoint images from the SDRAM 73, and applies various types of image processing including gradation conversion, white balance correction, and gamma correction. Then, the processed R and L viewpoint images are re-written to the SDRAM 73.

An image compression circuit 75 reads from the SDRAM 73 the R and L viewpoint images that have been processed by the image signal processing circuit 74. Then, the image compression circuit 75 compresses each of the R and L viewpoint images in a predetermined compression format such as TIFF or JPEG, and re-writes the compressed R and L viewpoint images to the SDRAM 73.

If the stereo camera 2 is in the 3D picture mode, a parallax image generator 76 reads the R and L viewpoint images compressed by the image compression circuit 75 from the SDRAM 73. The parallax image generator 76 generates multi-picture format parallax image from the R and L viewpoint images, and writes the parallax image to the SDRAM 73. An LCD driver 77 reads the parallax image or the R viewpoint image from the SDRAM 73 in response to a command from the CPU 70.

In a case where the stereo camera 2 is in the 3D picture mode, the LCD driver 77 reads the parallax image from the SDRAM 73. The LCD driver 77 divides each of the R and L viewpoint images contained in the parallax image into vertically long strips. Then, the LCD driver 77 alternately arranges the strips of the R and L viewpoint images into stripes so as to generate a display image on a lenticular lens system, which corresponds to the LCD 15. The LCD driver 77 converts the display image into an analog composite signal, and outputs the analog composite signal to the LCD 15. Thus, the stereoscopic image that provides the 3D view to the naked eyes is displayed as a live image on the LCD 15.

If the stereo camera 2 is in the 2D picture mode, on the other hand, the LCD driver 77 reads the R viewpoint image from the SDRAM 73. The LCD driver 77 converts the R viewpoint image into the analog composite signal, and outputs the analog composite signal to the LCD 15. Thus, in the 2D picture mode, the 2D image captured by the first imaging unit 3 is displayed as the live image on the LCD 15.

A medium controller 78 gets access to a recording medium 80 in response to a command from the CPU 70, and reads or writes the parallax image or the R viewpoint image from or to the recording medium 80, which is detachably loaded into a medium slot. If the stereo camera 2 is in the 3D picture mode, the CPU 70 writes the parallax image generated by the parallax image generator 76 to the recording medium 80 in response to the photographing command issued upon a full press of the shutter release button 11. If the stereo camera 2 is in the 2D picture mode, on the other hand, the CPU 70 writes to the recording medium 80 the R viewpoint image compressed by the image compression circuit 75 in the predetermined format in response to the photographing command issued upon the full press of the shutter release button 11.

To the data bus 72, an AE/AWB detector 82, an AF detector 83, a binary image generator 84, a shadow extracting section 85, a size calculating section 86, and a difference calculating section 87 are connected in addition to above. The AE/AWB detector 82 carries out AE (auto exposure) processing in which a photometric value representing subject brightness is calculated from the image data inputted from the image input controller 71 to the SDRAM 73, and inputs a calculation result to the CPU 70. The CPU 70 judges propriety of an exposure amount and white balance based on the photometric value inputted from the AE/AWB detector 82, and controls operation of the aperture stop 5c, 7c of each imaging unit 3, 4, an electronic shutter of each CCD 35, 55, and the like.

The AF detector 83 carries out so-called multipoint AF (auto focusing) processing, in which each of the R and L viewpoint images inputted from the image input controller 71 to the SDRAM 73 is divided into a plurality of areas, and a focal position is detected in each divided area by a contrast detection method. After detection of the focal position in every divided area of the R viewpoint image, the AF detector 83 calculates a distance to the subject based on the focal position on a divided area basis, and assumes that the divided area having the shortest distance contains the main subject. Then, the AF detector 83 determines the focal position of the divided area having the shortest distance as the focal position of the first imaging optical system 5. Likewise, as for the L viewpoint image, the AF detector 83 calculates the distance to the subject on a divided area basis based on the focal position of each divided area, and assumes that the divided area having the shortest distance contains the main subject. The focal position of the divided area having the shortest distance is determined as the focal position of the second imaging optical system 7.

After determination of the focal position of each imaging optical system 5, 7, the AF detector 83 inputs information about the focal positions to the CPU 70 and information about the divided areas containing the focal positions to the shadow extracting section 85. The CPU 70 drives each of the first and second focus motors 32 and 52 in response to the information about the respective focal positions inputted from the AF detector 83, and shifts each focusing lens 5b, 7b to the respective focal position in order to bring each of the first and second imaging optical systems 5 and 7 into focus.

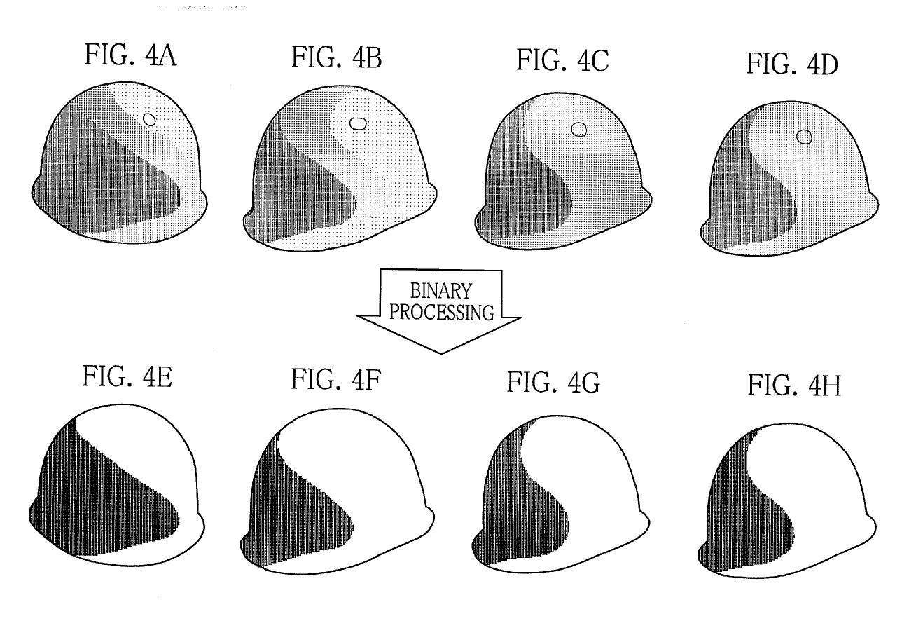

If the stereo camera 2 is in the automatic switching mode, the binary image generator 84 reads from the SDRAM 73 the R and L viewpoint images inputted from the image input controller 71, and converts each of the R and L viewpoint images into a binary image. The binary image generator 84 compares a brightness value of every pixel contained in each viewpoint image to a predetermined brightness threshold value. The binary image generator 84 turns into black the pixel having the brightness value smaller than the brightness threshold value, and turns into white the pixel having the brightness value equal to or larger than the brightness threshold value, in order to convert each viewpoint image into the binary image, as shown in FIGS. 4A to 4H. An area that includes the pixels having the brightness values smaller than the brightness threshold value, in other words, the area turned into black by binary processing is judged to be a shadow. Namely, the binary image generator 84 divides each image into a shadow area and a remaining area by the binary processing, as described above. The binary R and L viewpoint images produced by the binary image generator 84 are inputted to the shadow extracting section 85.

FIGS. 4A to 4D show examples of the R and L viewpoint images that are taken in a condition of the main subject being so disposed that the center of the main subject is approximately aligned to the center of the stereo camera 2. FIG. 4A is a main subject image contained in the L viewpoint image of a three-dimensional object, and FIG. 4B is a main subject image contained in the R viewpoint image of the three-dimensional object. FIG. 4C is a main subject image contained in the L viewpoint image of a printed sheet, and FIG. 4D is a main subject image contained in the R viewpoint image of the printed sheet. The binary image generator 84 converts the main subject images of FIGS. 4A, 4B, 4C, and 4D into the binary main subject images of FIGS. 4E, 4F, 4G, and 4H, respectively, by the binary processing.

The shadow extracting section 85 extracts the shadow of the main subject from each of the binary R and L viewpoint images based on the information about the divided area containing the focal position, which is inputted from the AF detector 83. The shadow extracting section 85 determines an approximate position of the main subject based on the information about the divided area, and then extracts an outline of the main subject from that position by using a well-known pattern recognition technique, for example. Then, the shadow extracting section 85 extracts a black area enclosed within the extracted outline as the shadow of the main subject.

The shadow extracting section 85 inputs shadow data of the main subject extracted from each of the binary R and L viewpoint images to the size calculating section 86. If the shadow is not extracted from the main subject of each of the R and L viewpoint images, the shadow extracting section 85 sends a shadow extraction impossible signal to the CPU 70.

The size calculating section 86 calculates a size of the shadow based on the shadow data inputted from the shadow extracting section 85. The size calculating section 86, for example, counts the number of pixels contained in the shadow, and multiplies the number of pixels by a size of the single pixel to calculate the size of the shadow. The size calculating section 86 inputs a calculation result to the difference calculating section 87.

The difference calculating section 87 calculates a difference in size of the shadow of the main subject between the R viewpoint image and the L viewpoint image, which are inputted from the size calculating section 86, and inputs a calculation result to the CPU 70.

Based on the difference in size of the shadow, which is inputted from the difference calculating section 87, the CPU 70 carries out switching judgment processing to judge switching between the 3D picture mode and the 2D picture mode. In a case where the main subject is the printed sheet, a change of a viewpoint causes only variation of a photographing angle relative to a plane, and hence the shape of the shadow hardly differs between the R viewpoint image and the L viewpoint image. In a case where the main subject is the three-dimensional object, on the other hand, the change of the viewpoint causes change of a view of the main subject itself, and hence the shape of the shadow largely differs between the R viewpoint image and the L viewpoint image. Thus, the difference in size of the shadow is large when the main subject is the three-dimensional object, while it is small when the main subject is the printed sheet.

For this reason, if an absolute value of the difference is a predetermined size difference threshold value or more, the CPU 70 distinguishes the main subject as the three-dimensional object, and puts the stereo camera 2 into the 3D picture mode. If the absolute value of the difference is smaller than the size difference threshold value, on the other hand, the CPU 70 distinguishes the main subject as the printed sheet, and puts the stereo camera 2 into the 2D picture mode. Therefore, in the automatic switching mode, the stereo camera 2 is automatically switched between the 3D picture mode and the 2D picture mode.

To the CPU 70, an EEPROM 88 is connected. The EEPROM 88 stores various types of programs and data to control the stereo camera 2. The CPU 70 appropriately reads the various programs or the like from the EEPROM 88, and executes various types of processing based on the programs to control each part of the stereo camera 2.

Various operation members including the shutter release button 11, the power switch 12, the mode switching dial 13, the zoom button 14, the menu button 16, and the cross key 17 are also connected to the CPU 70. These operation members detect operation by the user, and input a detection result to the CPU 70.

The shutter release button 11 is a two-step push switch. Upon a shallow press (half press) of the shutter release button 11, various types of photographing preparation processing including the AE processing and the multipoint AF processing are carried out. If the stereo camera 2 is put into the automatic switching mode, the switching judgment processing is carried out in response to the half press of the shutter release button 11. Following the half press, when the shutter release button 11 is deeply pressed (fully pressed), the imaging signal of a single screen captured by each of the first and second imaging units 3 and 4 is converted into the R or L viewpoint image. A preliminary photographing procedure refers to a series of processing steps carried out for duration from the half press until the full press of the shutter release button 11, and an actual photographing procedure refers to processing steps carried out after the full press of the shutter release button 11.

The power switch 12 is a slide switch (see FIG. 1). Upon sliding the power switch 12 into an ON position, electric power is supplied from a not-illustrated battery to each part, and the stereo camera 2 is actuated. Upon sliding the power switch 12 into an OFF position, on the other hand, the electric power supply is stopped, and the stereo camera 2 is turned off. When operation of the power switch 12 or the mode switching dial 13 is detected, the CPU 70 drives each of the first and second drive motors 31 and 51 in response to the detected operation, in order to retract or extend the first and second lens barrels 6 and 8.

Upon detecting operation of the zoom button 14, the CPU 70 drives each focus motor 32, 52, and shifts the zoom lens 5a, 7a in the optical axis direction. The CPU 70 disposes each zoom lens 5a, 7a in one of zoom positions, which are predetermined at established intervals between a wide angle end and a telephoto end, to change magnification of each imaging unit 3, 4. At this time, the CPU 70 synchronously drives the focus motors 32 and 52, and disposes the first and second zoom lenses 5a and 7a in the same zoom position.

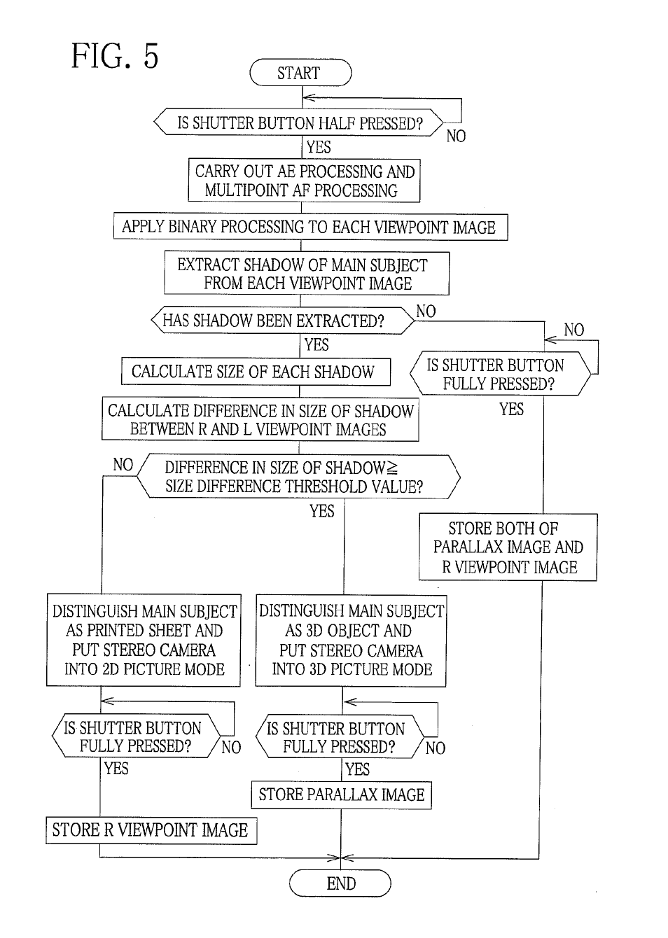

Next, operation in the automatic switching mode will be described with referring to a flowchart of FIG. 5. The stereo camera 2 is first actuated by operation of the power switch 12. In the photographing mode set by the mode switching dial 13, the live image is captured, and displayed on the LCD 15 through the use of the SDRAM 73. To take the image in the automatic switching mode, the mode switching dial 13 is turned to put the stereo camera 2 into the automatic switching mode. After that, the stereo camera 2 is pointed at the desired subject, and the shutter release button 11 is half pressed. In response to detection of the half press of the shutter release button 11, the CPU 70 of the stereo camera 2 commands the AE/AWB detector 82 to carry out the AE processing, and commands the AF detector 83 to carry out the multipoint AF processing.

In response to the command from the CPU 70, the AE/AWB detector 82 calculates the photometric value, and inputs the calculation result to the CPU 70. In response to the command from the CPU 70, the AF detector 83 detects the focal position of each of the first and second imaging optical systems 5 and 7. The AF detector 83 inputs the information about each focal position to the CPU 70, and inputs the information about the divided area containing each focal position to the shadow extracting section 85.

Upon input of the photometric value from the AE/AWB detector 82, the CPU 70 controls operation of the aperture stop 5c, 7c of the imaging unit 3, 4 and the electronic shutter of the CCD 35, 55 based on the photometric value, and adjusts the exposure amount and the white balance of each imaging unit 3, 4. Upon input of the information about the focal position from the AF detector 83, the CPU 70 drives the focus motor 32, 52 in accordance with the information, and shifts the focus lens 5b, 7b to the focal position in order to adjust the focus of each imaging optical system 5, 7.

The R and L viewpoint images captured after the AE processing and the multipoint AF processing are stored in the SDRAM 73. The binary image generator 84 reads the R and L viewpoint images from the SDRAM 73 in response to the command from the CPU 70, and applies the binary processing to each of the R and L viewpoint images (see FIG. 4A to 4H). Then, the binary image generator 84 inputs the binary R and L viewpoint images to the shadow extracting section 85.

The shadow extracting section 85 extracts the shadow of the main subject from each of the inputted binary R and L viewpoint images. If the shadow is properly extracted, the shadow data is inputted to the size calculating section 86. If the shadow is not extracted, on the other hand, the shadow extraction impossible signal is sent to the CPU 70.

Based on the shadow data of the main subject, the size calculating section 86 calculates the size of the shadow of the main subject in each viewpoint image, and inputs the calculation result to the difference calculating section 87. The difference calculating section 87 calculates the difference in size of the shadow of the main subject between the R and L viewpoint images. The calculation result is inputted to the CPU 70.

The CPU 70 judges whether or not the absolute value of the difference in size of the shadow, which is inputted from the difference calculating section 87, is the predetermined size difference threshold value or more. If the absolute value of the difference is judged to be the size difference threshold value or more, the main subject is distinguished as the three-dimensional object, and the stereo camera 2 is put into the 3D picture mode. If the absolute value of the difference is judged to be less than the size difference threshold value, the main subject is distinguished as the printed sheet, and the stereo camera 2 is put into the 2D picture mode. Thus, even if the printed sheet has the shadow, the main subject is automatically and appropriately distinguished between the three-dimensional object and the printed sheet. The stereo camera 2 does not require any sensor and any analyzing device for conduct of complex analysis, and thus does not result in upsizing and cost increase.

When the shutter release button 11 is fully pressed in a state of the stereo camera 2 being in the 3D picture mode, the actual photographing procedure is started, and the parallax image generated by the parallax image generator 76 is written to the recording medium 80. When the shutter release button 11 is fully pressed in a state of the stereo camera 2 being in the 2D picture mode, on the other hand, the R viewpoint image compressed in the predetermined format by the image compression circuit 75 is written to the recording medium 80.

In a case where the CPU 70 receives the shadow extraction impossible signal from the shadow extracting section 85, the CPU 70 writes the parallax image and the R viewpoint image to the recording medium 80 in response to the full press of the shutter release button 11, to obtain both of the parallax image and the R viewpoint image. This makes it possible to certainly obtain the image suitable for the subject, even if the image is took under such an illumination environment as not to cast the sharp shadow.

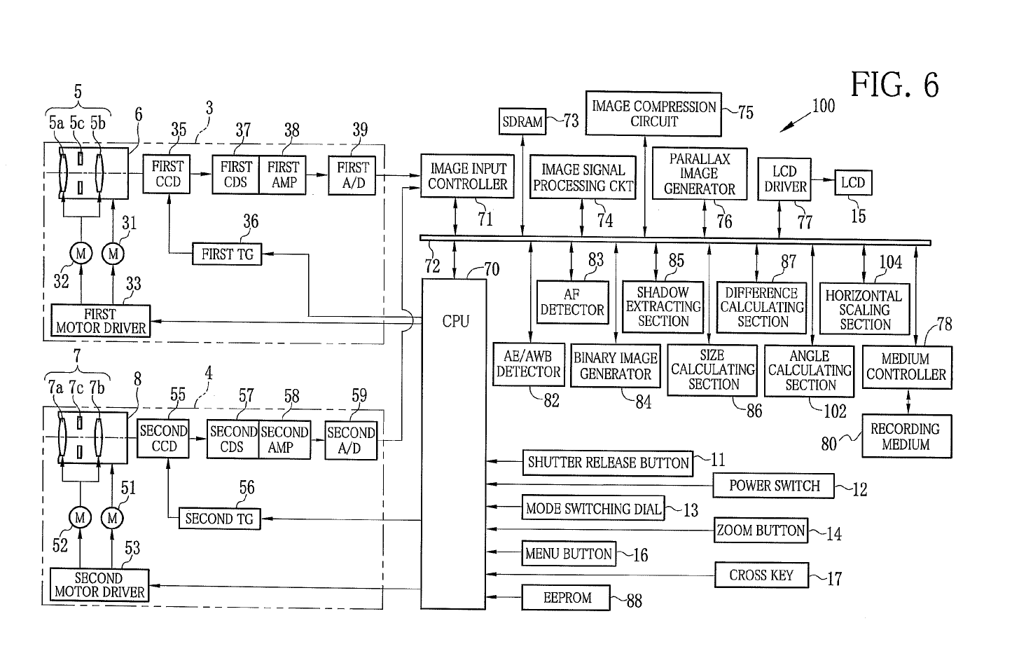

Next, a second embodiment of the present invention will be described. In the second embodiment, the same reference numbers as those of the first embodiment denote components having the same function and structure of those of the first embodiment, and the detailed description thereof will be omitted. As shown in FIG. 6, a stereo camera 100 according to the second embodiment is provided with an angle calculating section 102 and a horizontal scaling section 104.

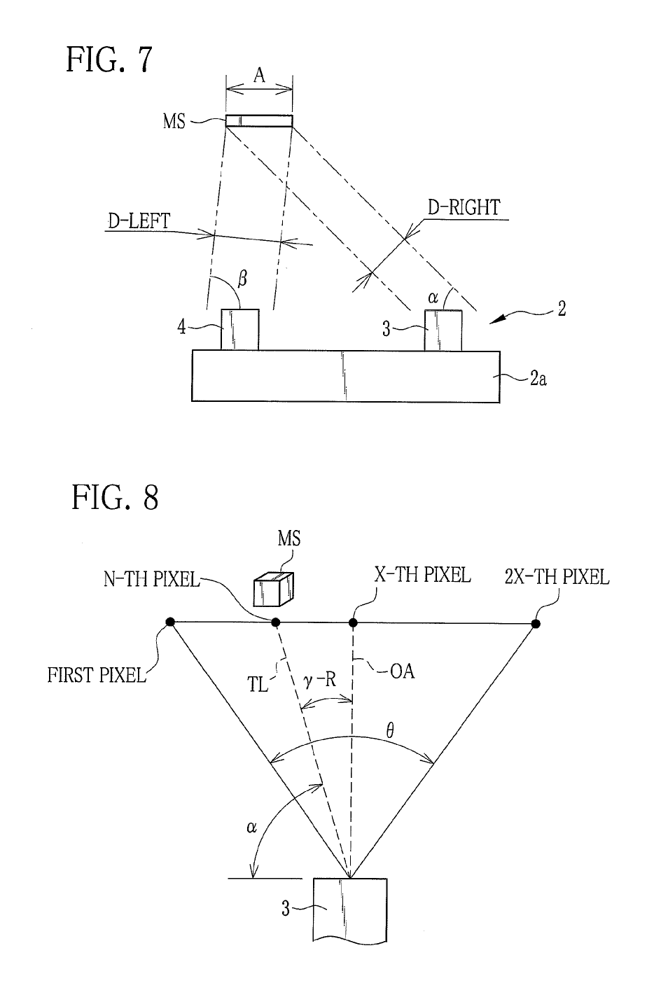

In response to a command from the CPU 70, the angle calculating section 102 reads from the SDRAM the R and L viewpoint images inputted from the image input controller 71. Then, the angle calculating section 102 calculates a horizontal photographing angle α (see FIG. 7) of the first imaging unit 3 relative to the main subject from the R viewpoint image, and a horizontal photographing angle β of the second imaging unit 4 relative to the main subject from the L viewpoint image. Then, the angle calculating section 102 inputs calculation results to the CPU 70.

To calculate the photographing angle α of the first imaging unit 3, as shown in FIG. 8, the angle calculating section 102 first calculates an angle γ−R that a line segment TL connecting the first imaging unit 3 to the main subject MS forms with an optical axis OA of the first imaging unit 3. The angle γ−R is obtained by the following expression (1).

$$γ - R = arctan \{ \frac{X - n}{X} \cdot tan ( \frac{θ}{2} ) \} \qquad ( 1 )$$

Wherein, θ represents a photographic field angle of the first imaging unit 3, and 2× represents the number of pixels of the first imaging unit 3 in a horizontal direction, and the n-th pixel captures an image of the center of the main subject MS, and the distance between the first imaging unit 3 and the main subject MS is ideally set at 1. In a like manner, an angle γ−L that a line segment TL′ connecting the second imaging unit 4 to the main subject MS forms with an optical axis OA′ of the second imaging unit 4 is obtained by the following expression (1′).

$$γ - L = arctan \{ \frac{{X}^{′} - {n}^{′}}{{X}^{′}} \cdot tan ( \frac{{θ}^{′}}{2} ) \} \qquad ( {1}^{′} )$$

Wherein, θ′ represents a photographic field angle of the second imaging unit 4, and 2×′ represents the number of pixels of the second imaging unit 4 in the horizontal direction, and the n′-th pixel captures the image of the center of the main subject MS, and the distance between the second imaging unit 4 and the main subject MS is ideally set at 1.

After calculation of the angles γ−R and γ−L, the angle calculating section 102 adds 90 degrees to each angle γ−R, γ−L, as shown by expressions (2) and (3), to calculate the photographing angle α, β.

α=(γ−R)+90 (2)

β=(γ−L)+90 (3)

Then, the angle calculating section 102 inputs the calculated photographing angles α and β to the CPU 70.

To the horizontal scaling section 104, the photographing angles α and β calculated by the angle calculating section 102 are inputted through the CPU 70, and the shadow data of the main subject of the R and L viewpoint images is inputted from the shadow extracting section 85. In response to a command from the CPU 70, the horizontal scaling section 104 deforms the shadow of the main subject of the R viewpoint image by stretching or shrinking the shadow by a predetermined amount in the horizontal direction (direction in which the first and second imaging units 3 and 4 align side by side). The horizontal scaling section 104 calculates a scaling rate P of the R viewpoint image by the following expression (4).

$$P = \frac{d - left}{d - right} = \frac{A \cdot sin β}{A \cdot sin α} = \frac{sin β}{sin α} \qquad ( 4 )$$

Wherein, as shown in FIG. 7, A represents the width of the main subject to be imaged, and d-right represents the width of the main subject viewed from the first imaging unit 3, and d-left represents the width of the main subject viewed from the second imaging unit 4.

After calculation of the scaling rate P, the horizontal scaling section 104 stretches or shrinks the shadow of the R viewpoint image at that scaling rate P. The horizontal scaling section 104 then inputs to the size calculating section 86 the processed shadow data of the R viewpoint image and the unprocessed shadow data of the L viewpoint image. The size calculating section 86, as in the case of the first embodiment, calculates the size of the shadow of the main subject in each of the processed R viewpoint image and the unprocessed L viewpoint image based on the shadow data inputted from the horizontal scaling section 104, and inputs calculation results to the difference calculating section 87.

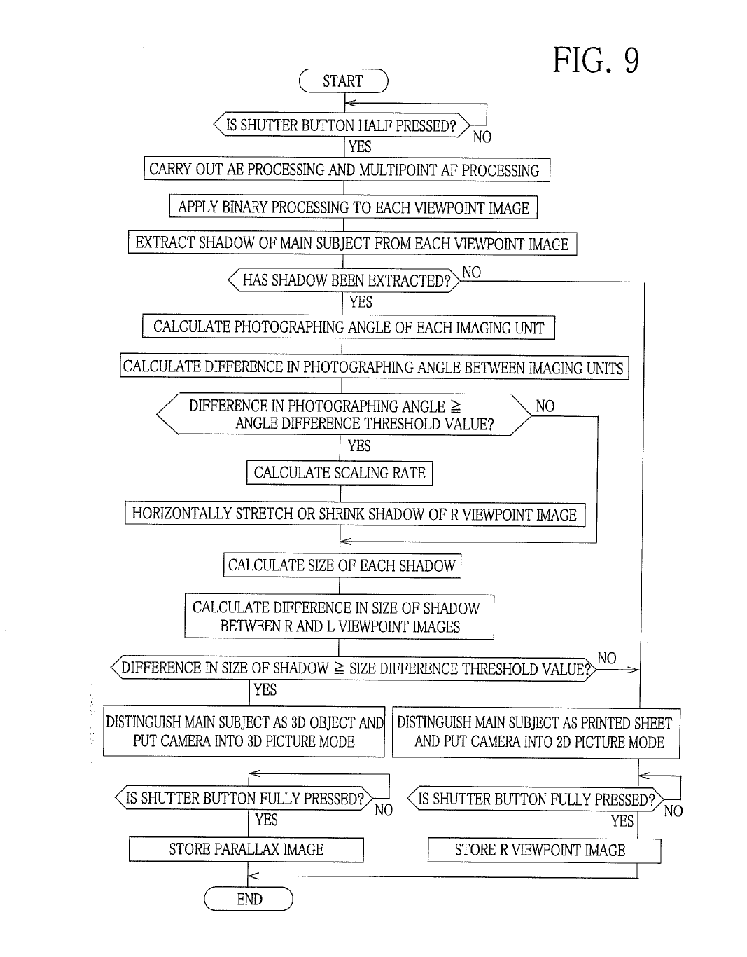

Next, operation of the stereo camera 100 according to the second embodiment will be described with referring to a flowchart of FIG. 9. When the stereo camera 100 is put into the automatic switching mode and the shutter release button 11 is half pressed, the preliminary photographing procedure is started. The AE processing and the multipoint AF processing are carried out, in order to adjust the exposure amount and the white balance of each imaging unit 3, 4 and adjust the focus of each imaging optical system 5, 7. Simultaneously, the binary image generator 84 applies the binary processing to each viewpoint image, and the binary R and L viewpoint images are inputted to the shadow extracting section 85.

The shadow extracting section 85 extracts the shadow of the main subject from each of the inputted binary R and L viewpoint images. The extracted shadow data is inputted to the size calculating section 86 and the horizontal scaling section 104. If the shadow is not extracted, on the other hand, the shadow extraction impossible signal is sent to the CPU 70.

If the shadow is properly extracted from each of the R and L viewpoint images by the shadow extracting section 85, the CPU 70 commands the angle calculating section 102 to calculate the photographing angles α and β of the first and second imaging units 3 and 4, respectively. In response to the command from the CPU 70, the angle calculating section 102 reads the R and L viewpoint images from the SDRAM 73, and calculates the photographing angles α and β by the above expressions (1) to (3). Then, the angle calculating section 102 inputs to the CPU 70 the calculated photographing angles α and β.

The CPU 70 calculates a difference (|α|−|β|) between absolute values of the photographing angles α and β inputted from the angle calculating section 102, and judges whether or not the difference is a predetermined angle difference threshold value or more. If the difference between the absolute values of the photographing angles α and β is judged to be the angle difference threshold value or more, the CPU 70 judges that the photographing angle α of the first imaging unit 3 relative to the main subject MS is largely different from the photographing angle β of the second imaging unit 4 relative to the main subject MS, in other words, the main subject MS is positioned not in the middle of the first and second imaging units 3 and 4, but on any side of the first and second imaging units 3 and 4. In this case, the CPU 70 commands the horizontal scaling section 104 to carry out scaling processing. At this time, the CPU 70 also inputs each photographing angle α, β to the horizontal scaling section 104, in addition to a scaling processing command.

In response to the command from the CPU 70, the horizontal scaling section 104 calculates the scaling rate P of the R viewpoint image by the above expression (4). The horizontal scaling section 104 stretches or shrinks at the calculated scaling rate P the shadow of the R viewpoint image inputted from the shadow extracting section 85. Then, the horizontal scaling section 104 inputs to the size calculating section 86 the processed shadow data of the R viewpoint image and the unprocessed shadow data of the L viewpoint image.

If the difference between the absolute values of the photographing angles α and β is judged to be smaller than the angle difference threshold value, on the other hand, the CPU 70 judges that the photographing angle α of the first imaging unit 3 relative to the main subject MS is almost equal to the photographing angle β of the second imaging unit 4 relative to the main subject MS, in other words, the main subject MS is positioned approximately in the middle of the first and second imaging units 3 and 4. The CPU 70 commands the size calculating section 86 to calculate the size of the shadow in each viewpoint image.

The size calculating section 86 calculates the size of each shadow based on the processed shadow data of the R viewpoint image inputted from the horizontal scaling section 104 and the unprocessed shadow data of the L viewpoint image, and inputs the calculation results to the difference calculating section 87. On the contrary, in a case where the difference between the absolute values of the photographing angles α and β is judged to be smaller than the angle difference threshold value, the size calculating section 86 calculates the size of each shadow based on the shadow data of the R and L viewpoint images inputted from the shadow extracting section 85, and inputs the calculation results to the difference calculating section 87.

The difference calculating section 87 calculates the difference in size of the shadow of the main subject between the R and L viewpoint images, and inputs the calculation result to the CPU 70. The CPU 70 judges whether or not the absolute value of the difference in size of the shadow inputted from the difference calculating section 87 is the predetermined size difference threshold value or more. If the absolute value of the difference in size of the shadow is judged to be the size difference threshold value or more, the main subject is distinguished as the three-dimensional object, and the stereo camera 2 is put into the 3D picture mode as a preparation to the actual photographing procedure. If the absolute value of the difference in size of the shadow is judged to be smaller than the size difference threshold value, on the other hand, the main subject is distinguished as the printed sheet, and the stereo camera 2 is put into the 2D picture mode.

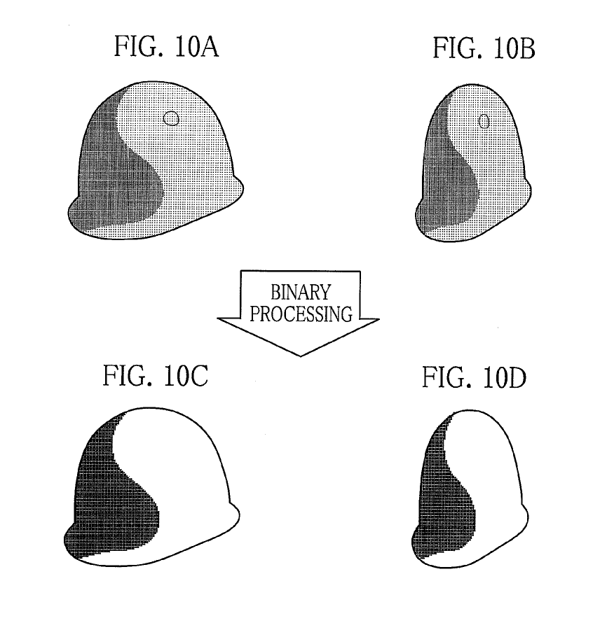

As shown in FIG. 7, in taking the image of the main subject MS being the printed sheet, if the horizontal photographing angles α and β of the first and second imaging units 3 and 4 relative to the main subject MS are largely different from each other, the width (horizontal size) of the main subject MS differs between the R and L viewpoint images, as shown in FIGS. 10A and 10B. Taking a case where, as shown in FIG. 7, the main subject MS is positioned approximately in front of the second imaging unit 4 and in a slanting direction relative to the first imaging unit 3, for example, the width of the main subject MS of the R viewpoint image becomes narrower than that of the L viewpoint image, as shown in FIGS. 10A and 10B.

In such a case, the width of the shadow becomes narrower in accordance with the width of the main subject MS in the image. Thus, if the difference in size of the shadow between the R and L viewpoint images is calculated in this state, the main subject MS may be mistakenly distinguished as the three-dimensional object, even though it is the printed sheet in actual fact. FIG. 10A shows an image of the main subject MS in the L viewpoint image took in a state of FIG. 7, and FIG. 10B shows an image of the main subject MS in the R viewpoint image took in the same state. FIG. 10C is a binary image of FIG. 10A, and FIG. 10D is a binary image of FIG. 10B.

However, as described above, the photographing angles α and β of the first and second imaging units 3 and 4 are calculated, and the scaling processing is carried out in a case where the absolute value of the difference between the photographing angles α and β is the predetermined angle difference threshold value or more, in order to correct a difference in width of the main subject MS due to the photographing angles. This allows precise distinction of the main subject MS between the three-dimensional object and the printed sheet, even if the photographing angle α of the first imaging unit 3 is largely different from the photographing angle β of the second imaging unit 4.

In this embodiment, the scaling processing is carried out in a case where the absolute value of the difference between the photographing angles α and β is the angle difference threshold value or more, but the scaling processing may be always carried out after calculation of the photographing angles α and β in accordance with these calculation results. In this embodiment, the shadow of the main subject of the R viewpoint image is scaled up or down, but the shadow of the main subject of the L viewpoint image may be instead scaled up or down, or the shadows of the main subject of both of the R and L viewpoint images may be relatively scaled up or down.

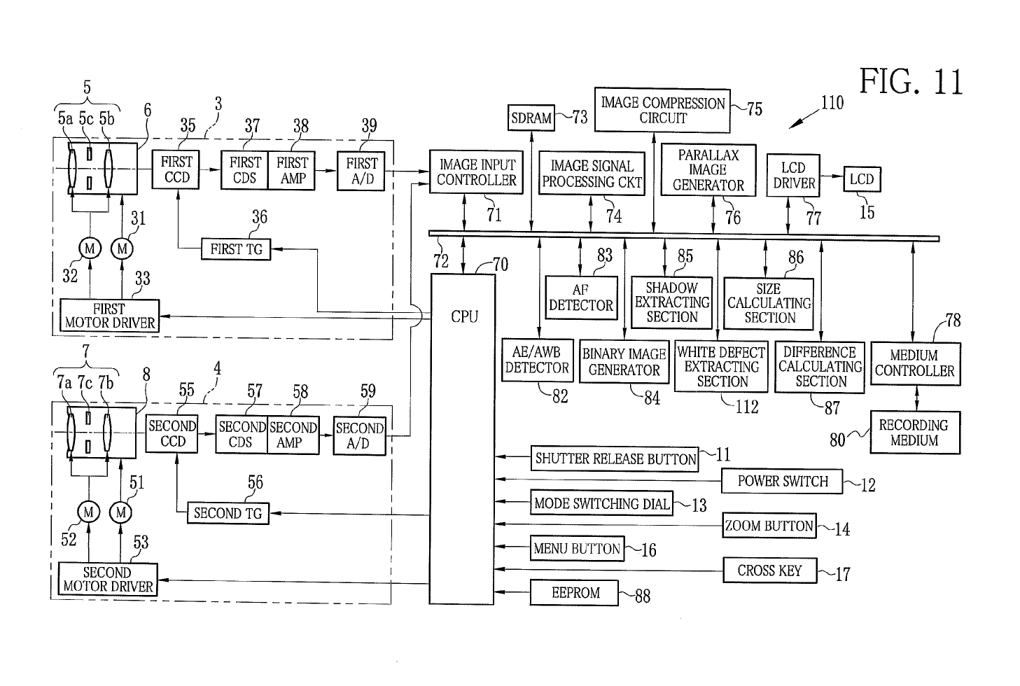

Next, a third embodiment of the present invention will be described. As shown in FIG. 11, a stereo camera 110 according to the third embodiment is provided with a white defect extracting section 112 to extract a white defect from each viewpoint image. The CPU 70 commands the binary image generator 84 to redo the binary processing, in the case of receiving the shadow extraction impossible signal from the shadow extracting section 85.

In response to a redo command of the binary processing from the CPU 70, the binary image generator 84 applies the binary processing to each viewpoint image with a higher brightness threshold value than that of the previous binary processing. In other words, the binary image generator 84 divides each viewpoint image into the shadow and the remaining area in the first binary processing. However, if the redo command is issued, the binary image generator 84 divides each viewpoint image into the white defect and a remaining area with use of the higher brightness threshold value. The binary image generator 84 inputs the binary image to a white defect extracting section 112.

To the white defect extracting section 112, not only the binary image is inputted from the binary image generator 84, but also the information about the divided area of the focal position is inputted from the AF detector 83. As in the case of the shadow extracting section 85, the white defect extracting section 112 extracts the white defect of the main object from each of the R and L viewpoint images, based on each of the binary R and L viewpoint images inputted from the binary image generator 84 and the information about the divided area containing the shortest focal position inputted from the AF detector 83. Then, the white defect extracting section 112 inputs extracted white defect data to the size calculating section 86. If the white defect is not extracted from the main subject of each viewpoint image, the white defect extracting section 112 sends a white defect extraction impossible signal to the CPU 70.

The size calculating section 86, as in the case of the shadow, calculates a size of the white defect of the main subject, which is inputted from the white defect extracting section 112, and inputs a calculation result to the difference calculating section 87.

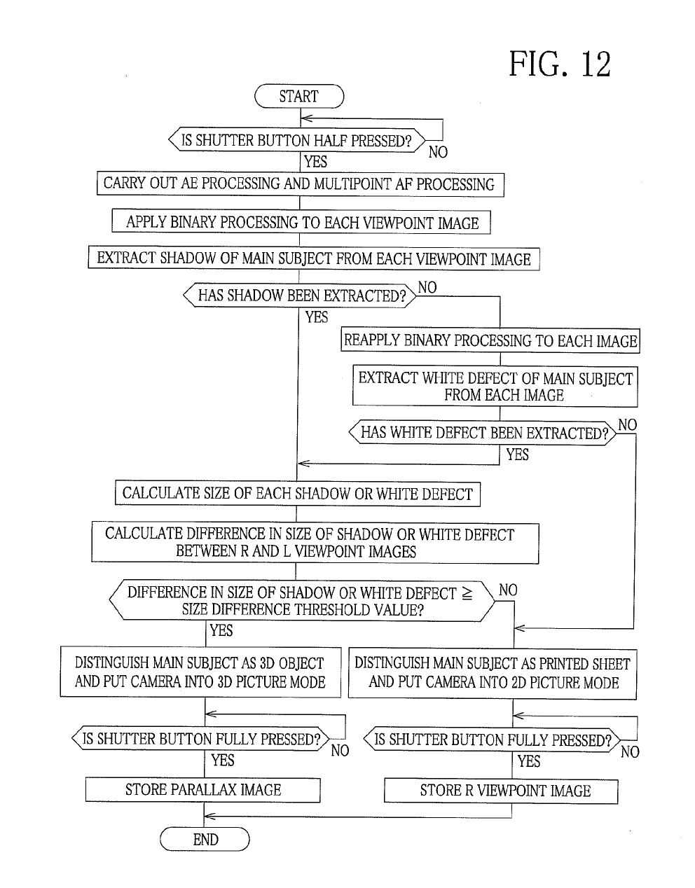

Now, operation of the stereo camera 110 according to the third embodiment will be described with referring to a flowchart of FIG. 12. When the stereo camera 110 is put into the automatic switching mode and the shutter release button 11 is half pressed, the AE processing and the multipoint AF processing are carried out in response to the half press of the shutter release button 11, to adjust the exposure amount and the white balance of each imaging unit 3, 4 and bring each imaging optical system 5, 7 into focus. At the same time, the binary image generator 84 applies the binary processing to each of the R and L viewpoint images, and the binary R and L viewpoint images are inputted to the shadow extracting section 85.

The shadow extracting section 85 applies the shadow extracting processing to each of the inputted binary R and L viewpoint images, in order to extract the shadow of the main subject. If the shadow is proper extracted, the shadow data is inputted to the size calculating section 86. If the shadow is not extracted, on the other hand, the shadow extraction impossible signal is sent to the CPU 70.

Upon input of the shadow data of the main subject, the size calculating section 86 calculates the size of the shadow, and inputs the calculation result to difference calculating section 87. The difference calculating section 87 calculates the difference in size of the shadow between the R and L viewpoint images, and inputs the calculation result to the CPU 70.

In the case of receiving the shadow extraction impossible signal from the shadow extracting section 85, the CPU 70 commands the binary image generator 84 to redo the binary processing. In response to the redo command, the binary image generator 84 applies the binary processing to each of the R and L viewpoint images with the higher brightness threshold value than that of the previous binary processing. Then, the binary R and L viewpoint images are inputted to the white defect extracting section 112.

The white defect extracting section 112 applies the white defect extracting processing to each of the inputted binary R and L viewpoint images, in order to extract the white defect of the main subject from each viewpoint image. If the white defect is extracted, the white defect data is inputted to the size calculating section 86. If the white defect is not extracted, on the other hand, the white defect extraction impossible signal is sent to the CPU 70.

The size calculating section 86 calculates the size of the white defect based on the white defect data of the main subject, and inputs a calculation result to the difference calculating section 87. The difference calculating section 87 calculates the difference in size of the white defect of the main subject between the R and L viewpoint images, and inputs a calculation result to the CPU 70.

In response to input of the difference in size of the shadow or the white defect from the difference calculating section 87, the CPU 70 judges whether or not the absolute value of the difference is the predetermined size difference threshold value or more. If the absolute value of the difference is judged to be the size difference threshold value or more, the main subject is distinguished as the three-dimensional object, and the stereo camera 110 is put into the 3D picture mode. If the absolute value of the difference is judge to be less than the size difference threshold value, the main subject is distinguished as the printed sheet, and the stereo camera 110 is put into the 2D picture mode. Thus, even if the shadow cannot be extracted, it is possible to appropriately distinguish the main subject between the three-dimensional object and the printed sheet. If the CPU 70 receives the white defect extraction impossible signal from the white defect extracting section 112, the main subject is distinguished as the printed sheet, and the stereo camera 110 is put into the 2D picture mode.

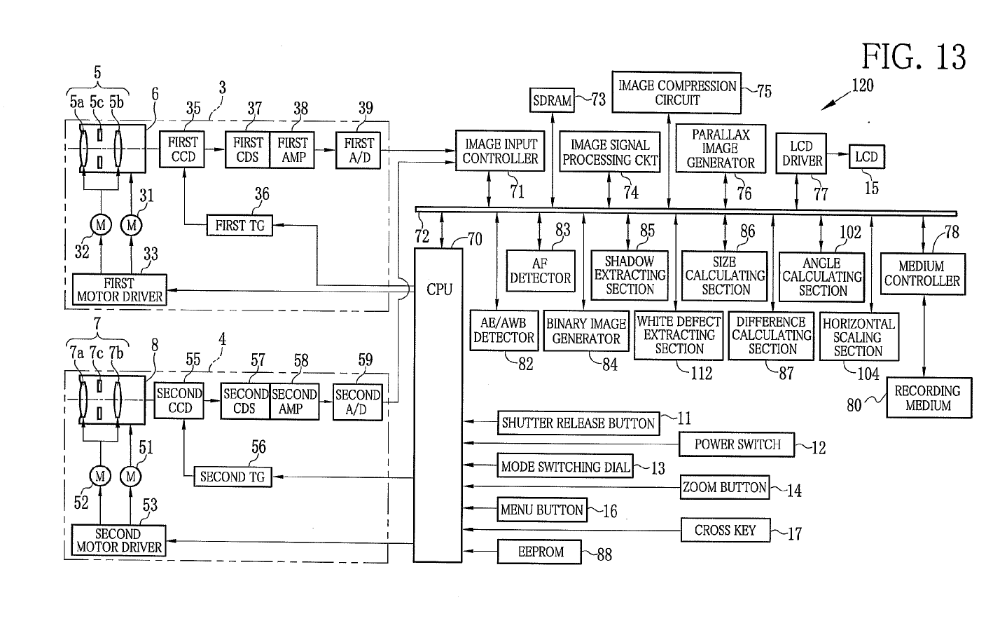

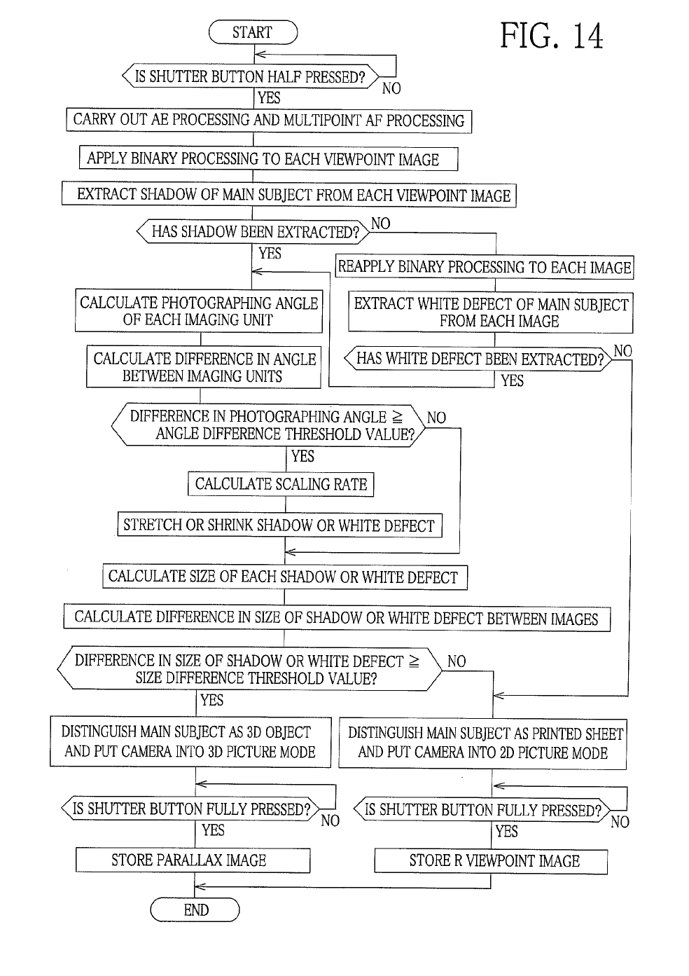

As shown in FIG. 13, a stereo camera 120 according to a fourth embodiment includes the angle calculating section 102, the horizontal scaling section 104, and the white defect extracting section 112. As shown in FIG. 14, if the shadow or the white defect is extracted from each viewpoint image, the photographing angle α, β of each imaging unit 3, 4 is calculated. Then, if the absolute value of the difference between the photographing angles α and β is the predetermined angle difference threshold value or more, the scaling processing is carried out to correct the difference in width of the main subject due to the difference in the photographing angles α and β. At this time, a means of calculating the photographing angles α and β and a means of the scaling processing are the same as those of the second embodiment.

In the above embodiments, the R viewpoint image is obtained in the 2D picture mode, but the L viewpoint image or both of the R and L viewpoint images may be obtained instead.

In the above embodiments, the distance from the stereo camera to the subject is calculated on a divided area basis by the multipoint AF processing, and it is assumed that the divided area having the shortest distance contains the main subject. However, the subject at shortest distance may be detected by stereo matching in each viewpoint image, and assumed as the main subject, for example. The main subject is not always at the shortest distance. Any subject can be assumed as the main subject as long as the subject is in both of the R and L viewpoint images.

In the above embodiments, the stereoscopic image is in the multi-picture format image file. The stereoscopic image may be, for example, the display image produced by the LCD driver. In the above embodiment, the 3D display is composed of the LCD and the lenticular lens disposed on the surface of the LCD. The 3D display may be composed of the LCD and a parallax barrier disposed on the surface of the LCD instead. In this case, an image on a parallax barrier system may be produced as the display image. Otherwise, the display image may be an image on a polarization display system, which needs for a viewer to wear polarization sensitive eyeglasses.

The present invention is applied to the stereo camera having the first and second imaging units in the above embodiments, but may be applied to a camera having three or more imaging units. Furthermore, the present invention may be applied to taking a moving image, in addition to taking a still image.

Although the present invention has been fully described by the way of the preferred embodiment thereof with reference to the accompanying drawings, various changes and modifications will be apparent to those having skill in this field. Therefore, unless otherwise these changes and modifications depart from the scope of the present invention, they should be construed as included therein.

What is claimed is:

1. A multi-eye camera having a plurality of imaging units, each of the imaging units capturing a viewpoint image, the viewpoint images captured by the imaging units constituting a parallax image for producing a stereoscopic view, the multi-eye camera being switchable between a 2D picture mode for obtaining the single viewpoint image and a 3D picture mode for obtaining the parallax image, the multi-eye camera comprising:
a shadow extracting section for extracting a shadow of a same subject from each of the viewpoint images captured in a preliminary photographing procedure;
a size calculating section for calculating a size of the shadow extracted from each of the viewpoint images by the shadow extracting section;
a difference calculating section for calculating a difference in the size of the shadow between the viewpoint images; and
a distinguishing section for distinguishing the subject as a three-dimensional object suited to the 3D picture mode if the difference is a size difference threshold value or more, and distinguishing the subject as a printed sheet suited to the 2D picture mode if the difference is less than the size difference threshold value.

2. The multi-eye camera according to claim 1, further comprising:
a mode switching section for automatically switching a photographing mode between the 2D picture mode and the 3D picture mode in accordance with a distinction result by the distinguishing section.

3. The multi-eye camera according to claim 2, wherein the preliminary photographing procedure is carried out upon a half press of a shutter release button, and an actual photographing procedure is carried out in the established photographing mode upon a full press of the shutter release button.

4. The multi-eye camera according to claim 3, further comprising:
an angle calculating section for calculating a photographing angle of each of the imaging units relative to the subject; and
a horizontal scaling section for calculating a scaling rate based on the photographing angles of the imaging units calculated by the angle calculating section, and horizontally stretching or shrinking at the scaling rate the shadow extracted from at least one of the viewpoint images,
wherein, the size calculating section calculates the size of the shadow after being processed by the horizontal scaling section.

5. The multi-eye camera according to claim 3, further comprising:
an image capture controller for obtaining both of the parallax image and the viewpoint image in the actual photographing procedure, if the shadow is not extracted from any of the viewpoint images.

6. The multi-eye camera according to claim 3, further comprising:
a white defect extracting section for extracting a white defect of the same subject from each of the viewpoint images, in a case where the shadow is not extracted from any of the viewpoint images,
wherein, the size calculating section calculates the size of the white defect extracted from each of the viewpoint images by the white defect extracting section,
the difference calculating section calculates a difference in the size of the white defect between the viewpoint images, and
the distinguishing section distinguishes the subject as the three-dimensional object if the difference is the size difference threshold value or more, and distinguishes the subject as the printed sheet if the difference is less than the size difference threshold value.

7. The multi-eye camera according to claim 6, further comprising:
an angle calculating section for calculating a photographing angle of each of the imaging units relative to the subject; and
a horizontal scaling section for calculating a scaling rate based on the photographing angles of the imaging units calculated by the angle calculating section, and horizontally stretching or shrinking at the scaling rate the white defect extracted from at least one of the viewpoint images,
wherein, the size calculating section calculates the size of the white defect after being processed by the horizontal scaling section.

8. A method for distinguishing whether a subject is a three-dimensional object or a printed sheet based on a plurality of viewpoint images, the method comprising the steps of:
extracting a shadow of the subject from each of the viewpoint images in a preliminary photographing procedure;
calculating a size of the extracted shadow;
calculating a difference in the size of the shadow between the viewpoint images; and
distinguishing the subject as the three-dimensional object if the difference is a size difference threshold value or more, and distinguishing the subject as the printed sheet if the difference is less than the size difference threshold value.

9. The method according to claim 8, further comprising the step of:
switching a photographing mode to a 3D picture mode for obtaining a parallax image if the subject is distinguished as the three-dimensional object, and switching the photographing mode to a 2D picture mode for obtaining the single viewpoint image if the subject is distinguished as the printed sheet.

10. The method according to claim 9, wherein the preliminary photographing procedure is carried out upon a half press of a shutter release button, and an actual photographing procedure is carried out in the established photographing mode upon a full press of the shutter release button.
